(19) United States
(12) Patent Application Publication
(10) Pub. No.: US 2026/0299387 A1
(43) Pub. Date: Oct. 1, 2026

(54) ILLUMINATION CONTROL METHOD AND ILLUMINATION DEVICE

(71) Applicant: SEIKO EPSON CORPORATION, Tokyo (JP)

(72) Inventors: Rui ARUGA, Azumino-Shi (JP); Shinnosuke ARAKI, Matsumoto-Shi (JP)

(21) Appl. No.: 19/577,568

(22) Filed: Mar. 25, 2026

(30) Foreign Application Priority Data
Mar. 26, 2025 (JP) 2025-051226

(51) Int. Cl. G03B 21/20; G09G 3/00

(52) U.S. Cl. CPC G03B 21/2033; G03B 21/2013; G09G 3/002; G09G 2320/0626; G09G 2354/00

(57) ABSTRACT

An illumination control method includes: accepting a first input representing a first combination that is a combination of a lighting and blinking pattern and a light emission color of a plurality of light sources in a first mode; accepting a second input representing a second combination that is a combination of a lighting and blinking pattern and a light emission color of the plurality of light sources in a second mode; controlling a brightness of the plurality of light sources when an input device accepts a first operation; causing the plurality of light sources to emit light in the first mode, based on the first combination, when the input device accepts a second operation different from the first operation; and causing the plurality of light sources to emit light in the second mode, based on the second combination, when the input device accepts the second operation again.

The present application is based on, and claims priority from JP Application Serial Number 2025-051226, filed Mar. 26, 2025, the disclosure of which is hereby incorporated by reference herein in its entirety.

### BACKGROUND

### 1. Technical Field

The present disclosure relates to an illumination control method and an illumination device.

### 2. Related Art

JP-A-2018-28965 describes an illumination device configured to be able to switch the on-off state of an illumination light source of an illumination unit and a light source of a projection-type video display unit to at least (1) a state where both the illumination light source of the illumination unit and the light source of the projection-type video display unit are off, (2) a state where the illumination light source of the illumination unit is on and the light source of the projection-type video display unit is off, and (3) a state where the illumination light source of the illumination unit is off and the light source of the projection-type video display unit is on. The switching between these states is performed using a switch or a remote controller.

JP-A-2018-28965 is an example of the related art.

JP-A-2018-28965 includes no description about how colors are used in the illumination unit. Therefore, only a simple illumination function of substantially turning on and off can be realized. Under such circumstances, there is a demand that more varied expressions should be easily created by illumination.

### SUMMARY

An illumination control method according to an aspect of the present disclosure includes: accepting a first input representing a first combination that is a combination of a lighting and blinking pattern and a light emission color of a plurality of light sources in a first mode; accepting a second input representing a second combination that is a combination of a lighting and blinking pattern and a light emission color of the plurality of light sources in a second mode and is different from the first combination; controlling a brightness of the plurality of light sources when an input device disposed in a housing of an illumination device including the plurality of light sources accepts a first operation; causing the plurality of light sources to emit light in the first mode, based on the first combination, when the input device accepts a second operation different from the first operation; and causing the plurality of light sources to emit light in the second mode, based on the second combination, when the input device accepts the second operation again.

An illumination device according to another aspect of the present disclosure includes: a plurality of light sources; a housing in which the plurality of light sources are disposed; an input device that is disposed in the housing and accepts a first operation and a second operation different from the first operation; and a control device that executes accepting a first input representing a first combination that is a combination of a lighting and blinking pattern and a light emission color of the plurality of light sources in a first mode, accepting a second input representing a second combination that is a combination of a lighting and blinking pattern and a light emission color of the plurality of light sources in a second mode and is different from the first combination, controlling a brightness of the plurality of light sources when the input device accepts the first operation, causing the plurality of light sources to emit light in the first mode, based on the first combination, when the input device accepts the second operation, and causing the plurality of light sources to emit light in the second mode, based on the second combination, when the input device accepts the second operation again.

### BRIEF DESCRIPTION OF THE DRAWINGS

FIG. 1 schematically shows a system used for an illumination control method according to an embodiment.

FIG. 2 is a block diagram of an illumination device and a terminal device.

FIG. 3 illustrates an example of a housing of the illumination device.

FIG. 4 illustrates a plurality of light sources provided at a top surface of the housing shown in FIG. 3.

FIG. 5 illustrates a plurality of light sources provided at a side surface of the housing shown in FIG. 3.

FIG. 6 is a flowchart showing a flow of the illumination control method according to the embodiment.

FIG. 7 illustrates a first operation.

FIG. 8 illustrates a second operation.

FIG. 9 illustrates another example of the first operation.

FIG. 10 illustrates another example of the second operation.

FIG. 11 illustrates an example of a display used for accepting a first input and a second input.

FIG. 12 illustrates an example of a display used for setting a first mode and a second mode.

FIG. 13 illustrates an example of a display used for changing a lighting and blinking pattern of a plurality of light sources.

FIG. 14 illustrates an example of a display used for changing light emission colors of a plurality of light sources.

### DESCRIPTION OF EMBODIMENTS

A preferred embodiment according to the present disclosure will be described below with reference to the accompanying drawings. In the drawings, the dimensions and scales of units are different from actual ones as appropriate, and some parts are schematically illustrated in order to facilitate understanding. The scope of the present disclosure is not limited to the embodiment unless the description given below includes any description to the effect that the present disclosure is limited.

### 1. Embodiment

### 1-1. Overview of System

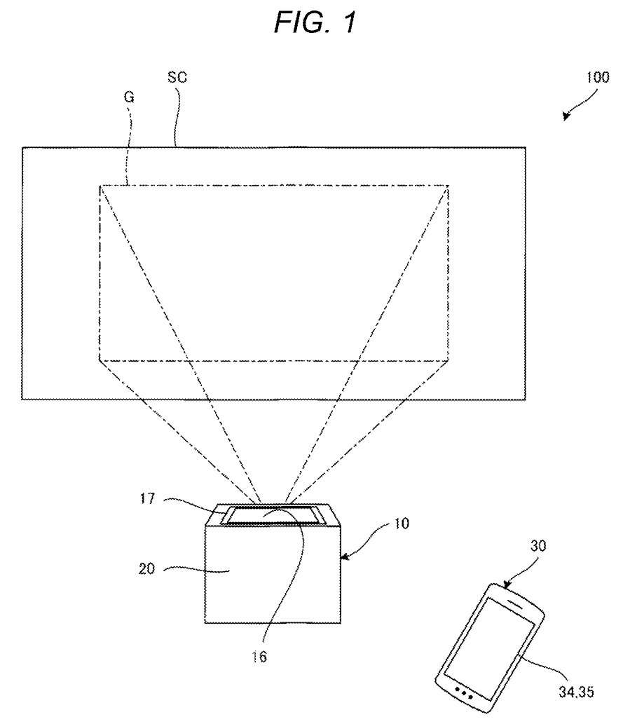

FIG. 1 schematically shows a system 100 used for an illumination control method according to an embodiment. As illustrated in FIG. 1, the system 100 includes an illumination device 10 and a terminal device 30.

The illumination device 10 is a device having an illumination function. In the present embodiment, the illumination device 10 has a projection function of projecting an image G on a projection surface SC in addition to the illumination function. The projection surface SC is an object such as a screen or a wall. The projection surface SC is not limited to a planar surface and may be, for example, a curved surface. The projection function is used as necessary and may be omitted. The illumination device 10 may have a function different from the projection function, as a function other than the illumination function.

The illumination device 10 includes a housing 20, and an input device 16 and an illumination unit 17 are disposed in the housing 20. As will be described in detail later, in the illumination device 10, a light emission state such as the brightness, the lighting and blinking pattern, and the light emission color of a plurality of light sources 17a, described later, that form the illumination unit 17 is controlled, based on an input result at the input device 16. The lighting and blinking pattern of the plurality of light sources 17a is a combination of turning on or off of each of the plurality of light sources 17a. As an example, all the light sources 17a may be turned on, or the light sources 17a to be turned on and the light sources 17a to be turned off may be alternately arranged. The combination is not limited and is freely set. Moreover, the lighting and blinking pattern of the plurality of light sources 17a may include a pattern that changes in time series. For example, control to turn on a part of all the light sources 17a is performed while the light sources 17a to be turned on are sequentially shifted, and this enables the light to appear to be moving. The lighting and blinking pattern of the plurality of light sources 17a may include a plurality of patterns having different rates of change in time series.

The terminal device 30 is a device communicably coupled to the illumination device 10, and has a function of controlling the operation of the illumination device 10 and a function of changing settings of the illumination device 10. More specifically, the terminal device 30 has a function of performing control and configuring settings of the illumination unit 17.

In the illustrated example, the terminal device 30 is a smartphone. However, the terminal device 30 is not limited to a smartphone and may be, for example, a laptop or desktop computer or a tablet terminal.

### 1-2. Illumination Device and Terminal Device

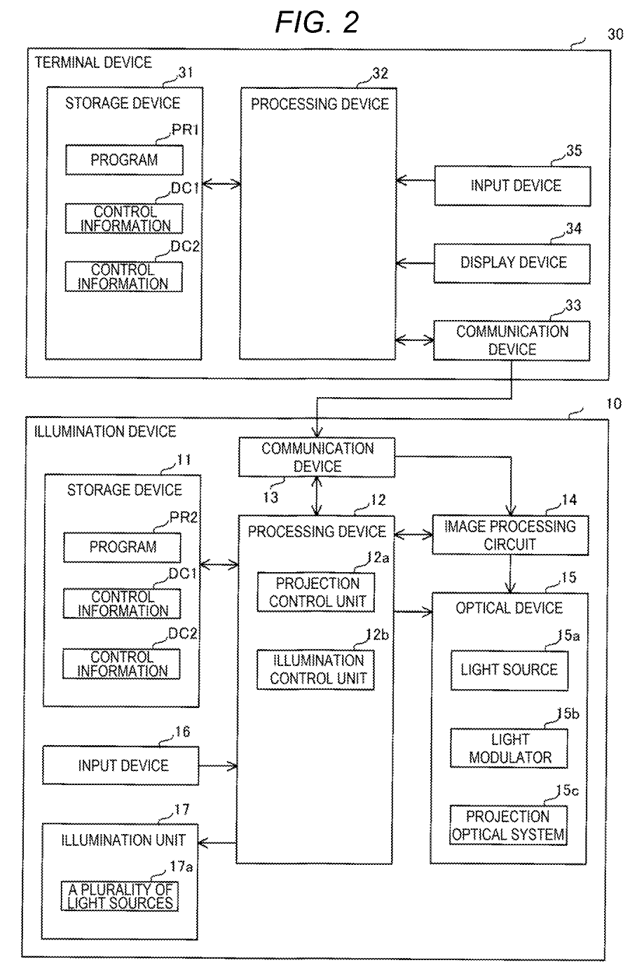

FIG. 2 is a block diagram of the illumination device 10 and the terminal device 30. As illustrated in FIG. 2, the illumination device 10 includes a storage device 11, a processing device 12, a communication device 13, an image processing circuit 14, an optical device 15, the input device 16, and the illumination unit 17. These devices are communicably coupled to each other. The processing device 12 is an example of a "control device". When the illumination device 10 does not have a projection function, the image processing circuit 14 and the optical device 15 may be omitted.

The storage device 11 is a storage device that stores a program to be executed by the processing device 12 and data to be processed by the processing device 12. The storage device 11 includes, for example, a hard disk drive or a semiconductor memory. A part or the entirety of the storage device 11 may be provided in a storage device, a server, or the like outside the illumination device 10.

The storage device 11 stores a program PR2, control information DC1, and control information DC2.

The program PR2 is a program for executing an illumination control method, described later, together with the program PR1, described later. The control information DC1 is control information of a first mode based on a first input, described later, and represents a first combination that is a combination of the lighting and blinking pattern and the light emission color of the plurality of light sources 17a in the first mode. The control information DC2 is control information of a second mode based on a second input, described later, and indicates a second combination that is a combination of the lighting and blinking pattern and the light emission color of the plurality of light sources 17a in the second mode. The second combination is different from the first combination. Hereinafter, the lighting and blinking pattern of the plurality of light sources 17a may be referred to as a light emission pattern.

The processing device 12 is a processing device having a function of controlling each part of the illumination device 10 and a function of processing various data. The processing device 12 includes, for example, at least one processor such as a CPU (central processing unit). The processing device 12 may be configured with a single processor or may be configured with a plurality of processors. A part or all of the functions of the processing device 12 may be implemented by hardware such as a DSP (digital signal processor), an ASIC (application-specific integrated circuit), a PLD (programmable logic device), or an FPGA (field-programmable gate array). The processing device 12 may be integrated with the image processing circuit 14.

The communication device 13 is a communication device that can communicate with various devices, and communicates with the terminal device 30 and acquires video data from a device, not illustrated. For example, the communication device 13 is a wireless communication device such as LPWA (low power wide area), a wireless LAN including Wi-Fi, or Bluetooth. "Wi-Fi" and "Bluetooth" are registered trademarks. However, the communication device 13 is not limited to a wireless communication device and may be, for example, a wired communication device such as a wired LAN (local area network), a USB (universal serial bus), or an HDMI (high-definition multimedia interface). "HDMI" is a registered trademark.

The image processing circuit 14 is a circuit that performs necessary processing on video data from the communication device 13 and inputs the video data to the optical device 15. The image processing circuit 14 includes, for example, a frame memory and a processor, not illustrated, loads the video data in the frame memory, executes various kinds of processing such as resolution conversion processing, resize processing, and distortion correction processing on the video data as appropriate, and inputs the video data to the optical device 15. The image processing circuit 14 may execute, according to need, processing such as OSD (on-screen display) processing of generating image information for menu display, operation guide, or the like and combining the image information with the video data. Similarly to the processing device 12, the processor of the image processing circuit 14 is configured with, for example, a single or a plurality of processors, such as a CPU or CPUs.

The optical device 15 is a device that projects image light onto the projection surface SC. The optical device 15 includes a light source 15a, a light modulator 15b, and a projection optical system 15c.

The light source 15a includes a light source such as a halogen lamp, a xenon lamp, an ultrahigh-pressure mercury lamp, an LED (light-emitting diode), or a laser light source, and outputs red light, green light, and blue light. The light modulator 15b draws an image based on the video data supplied from the terminal device 30. The light modulator 15b includes three light modulation elements provided corresponding to red, green, and blue. The light modulation elements include, for example, transmissive liquid crystal panels, reflective liquid crystal panels, or DMDs (digital mirror devices), and modulate light of the corresponding colors and thus generate image lights of the respective colors. The image lights of the respective colors generated by the light modulator 15b are combined together by a color combining optical system and thus form a full-color image light. The projection optical system 15c is an optical system including a projection lens or the like that forms an image of the full-color image light from the light modulator 15b and projects the image onto the projection surface SC. The image drawn by the light modulator 15b, that is, a drawn image, is projected onto the projection surface SC via the projection lens.

The input device 16 is a device that accepts an operation from a user. In the present embodiment, the input device 16 is a touch sensor. The input device 16 is not limited to a touch sensor and may be, for example, a proximity sensor, a button switch, or a slide bar as long as the input device 16 accepts an operation of the user touching or approaching the illumination device 10.

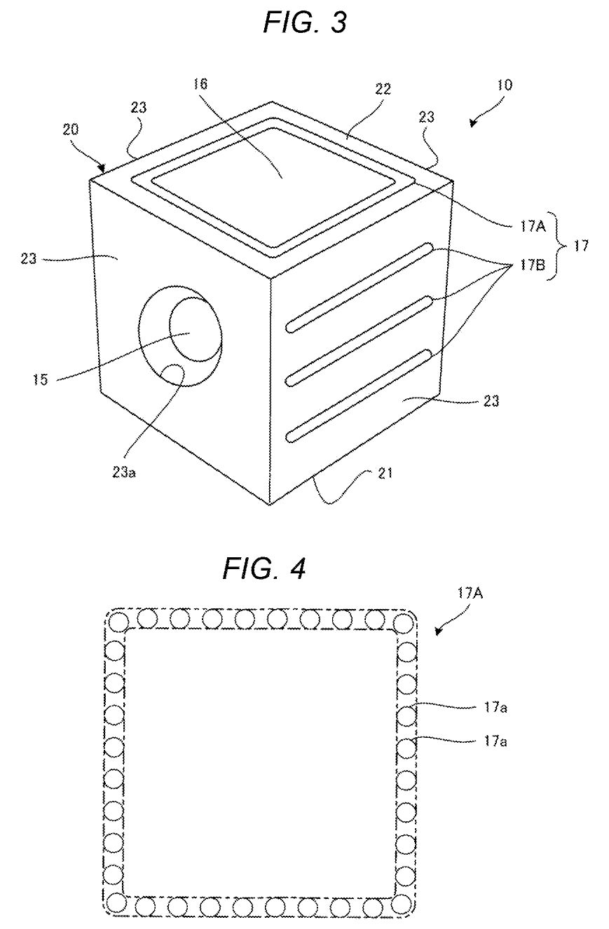

The illumination unit 17 includes a plurality of light sources 17a. Each light source 17a is, for example, a light-emitting element such as a full-color LED element that can change the light emission color and brightness, and can change the luminance ratio of red light, green light, and blue light. Each light source 17a emits light in various emission colors by variously changing the luminance ratio of the respective colors. The arrangement of the plurality of light sources 17a will be described later with reference to FIGS. 3-5. In addition to the light-emitting element, the illumination unit 17 may also include a substrate where the light-emitting element is disposed, a drive circuit that drives the light-emitting element, or the like. The illumination unit 17 may be referred to as a light-emitting element array, a light source array, a light source substrate, a light source module, or the like.

In the illumination device 10 described above, the processing device 12 executes the program PR2 stored in the storage device 11 and thus functions as a projection control unit 12a and an illumination control unit 12b. Therefore, the processing device 12 includes the projection control unit 12a and the illumination control unit 12b.

The projection control unit 12a controls the operations of the image processing circuit 14 and the optical device 15. More specifically, the projection control unit 12a controls the operations of the image processing circuit 14 and the optical device 15 to project the image G onto the projection surface SC.

The illumination control unit 12b controls the driving of the illumination unit 17. More specifically, the illumination control unit 12b acquires the control information DC1 and the control information DC2 from the terminal device 30 via the communication device 13, and causes the storage device 11 to store the acquired control information DC1 and control information DC2. Also, the illumination control unit 12b controls the light emission state of the illumination unit 17 such as the brightness, the light emission pattern, or the light emission color thereof according to light emission information based on the control information DC1 or the control information DC2, based on an input result at the input device 16.

As illustrated in FIG. 2, the terminal device 30 includes a storage device 31, a processing device 32, a communication device 33, a display device 34, and an input device 35. These devices are communicably coupled to each other.

The storage device 31 is a storage device that stores programs such as an operating system and application programs to be executed by the processing device 32 and data to be processed by the processing device 32. The storage device 31 includes, for example, a hard disk drive or a semiconductor memory. A part or the entirety of the storage device 31 may be an external storage device of the terminal device 30 or may be provided in an external device such as a server connected to the terminal device 30 via a communication network such as the internet.

The storage device 31 stores a program PR1, control information DC1, and control information DC2.

The program PR1 is a program for executing the illumination control method, described later, together with the above-described program PR2.

The processing device 32 is a processing device having a function of controlling each part of the terminal device 30 and a function of processing various data. The processing device 32 includes a processor such as a CPU. The processing device 32 may be configured with a single processor or may be configured with a plurality of processors. A part or all of the functions of the processing device 32 may be implemented by hardware such as a DSP, an ASIC, a PLD, or an FPGA.

The communication device 33 is a communication device that can communicate with the illumination device 10 and the like. For example, the communication device 33 is a wireless communication device such as LPWA, a wireless LAN including Wi-Fi, or Bluetooth. "Wi-Fi" and "Bluetooth" are registered trademarks. The communication device 33 may be a wired communication device such as a wired LAN, a USB, or an HDMI. "HDMI" is a registered trademark. The communication device 33 may be able to communicate with another device than the illumination device 10.

The display device 34 displays various images under the control of the processing device 32. The display device 34 is a display device including various display panels such as a liquid crystal display panel and an organic EL (electro-luminescence) display panel.

The input device 35 is an input device that accepts an operation from the user. For example, the input device 35 includes a pointing device such as a touch pad, a touch panel, or a mouse. When the input device 35 includes a touch panel, the input device 35 may also serve as the display device 34.

In the terminal device 30 described above, the processing device 32 executes the program PR1 stored in the storage device 31 and thus implements various functions necessary for the illumination control method, described later. More specifically, the processing device 32 causes the display device 34 to display an image GU, described later, that is used for control and settings of the illumination unit 17, generates the control information DC1 and the control information DC2 based on an input result at the input device 35 using the image GU, described later, and causes the communication device 33 to transmit the control information DC1 and the control information DC2 to the illumination device 10.

### 1-3. Plurality of Light Sources

FIG. 3 illustrates an example of the housing 20 of the illumination device 10. In the example illustrated in FIG. 3, the housing 20 has a cubic shape having a bottom surface 21, a top surface 22, and four side surfaces 23. The input device 16, which is a touch sensor, and an illumination unit 17A, which is a part of the illumination unit 17, are installed at the top surface 22. Also, an opening 23a for allowing projection from the optical device 15 is provided at one side surface 23, of the four side surfaces 23, and three illumination units 17B, which are the rest of the illumination unit 17, are provided at another side surface 23.

As described above, in the illustrated example, the illumination unit 17 is divided into the illumination unit 17A and the three illumination units 17B. The illumination unit 17A has an annular shape so as to surround the input device 16 along the outer peripheral edge of the top surface 22. The three illumination units 17B are lined up in a direction in which the bottom surface 21 and the top surface 22 are lined up, and each illumination unit 17B extends in a direction intersecting the direction in which the bottom surface 21 and the top surface 22 are lined up. Each of the illumination unit 17A and the illumination units 17B described above includes a plurality of light sources 17a.

The shape of the housing 20 is not limited to the illustrated example and is freely set. Also, the arrangement, shape, number, and the like of the illumination units 17 are not limited to the illustrated example and are freely set.

FIG. 4 illustrates the plurality of light sources 17a provided at the top surface 22 of the housing 20 illustrated in FIG. 3. As shown in FIG. 4, the illumination unit 17A includes the plurality of light sources 17a arranged annularly along the contour of the top surface 22. In the illustrated example, the number of light sources 17a provided in the illumination unit 17A is 36. However, the number of light sources 17a provided in the illumination unit 17A is not limited to the illustrated example and is freely set.

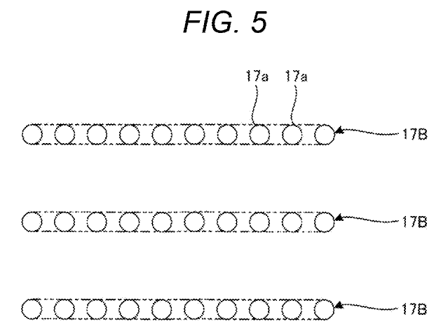

FIG. 5 illustrates the plurality of light sources 17a provided at the side surface 23 of the housing 20 illustrated in FIG. 3. As shown in FIG. 5, each illumination unit 17B includes the plurality of light sources 17a arranged in a straight line. In the illustrated example, the number of light sources 17a provided in each illumination unit 17B is 10. However, the number of light sources 17a provided in each illumination unit 17B is not limited to the illustrated example and is freely set. Also, the number of illumination units 17B is not limited to the illustrated example and may be two or fewer or four or more.

The plurality of light sources 17a provided in the illumination unit 17A and the illumination units 17B described above can individually control the light emission color and brightness. Thus, the light emission pattern and the light emission color of the plurality of light sources 17a provided in the illumination unit 17A and the illumination units 17B can be variously changed. Variations of the light emission pattern and the light emission color will be described later with reference to FIG. 3 and the like.

### 1-4. Illumination Control Method

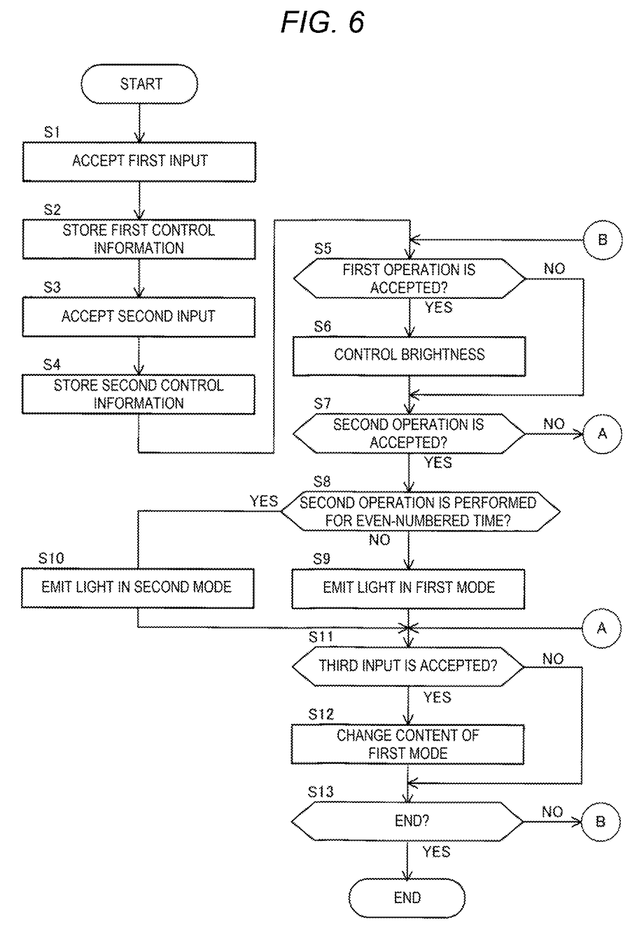

FIG. 6 is a flowchart showing the flow of the illumination control method according to the embodiment. The illumination control method illustrated in FIG. 6 includes steps S1 to S13. These steps are executed by the processing device 12. That is, the processing device 12 executes steps S1 to S13.

Specifically, first, in step S1, the processing device 12 accepts a first input. More specifically, in step S1, the processing device 12 functioning as the illumination control unit 12b receives the control information DC1 from the terminal device 30 via the communication device 13 and thus receives the first input represented by the control information DC1. The first input represents a first combination that is a combination of the lighting and blinking pattern and the light emission color of the plurality of light sources 17a in the first mode.

After step S1, in step S2, the processing device 12 stores the control information DC1 of the first mode based on the first input. More specifically, the processing device 12 functioning as the illumination control unit 12b stores the received control information DC1 in the storage device 11. The execution of step S2 may be performed at any point after step S1 and before step S5 and is not limited to the illustrated example.

After step S2, in step S3, the processing device 12 accepts a second input. More specifically, in step S3, the processing device 12 functioning as the illumination control unit 12b receives the control information DC2 from the terminal device 30 via the communication device 13 and thus accepts the second input represented by the control information DC2. The second input represents a second combination that is a combination of the lighting and blinking pattern and the light emission color of the plurality of light sources 17a in the second mode and is different from the first combination. The execution of step S3 may be performed at any point before step S4 and is not limited to the illustrated example.

After step S3, in step S4, the processing device 12 stores the control information DC2 of the second mode based on the second input. More specifically, the processing device 12 functioning as the illumination control unit 12b stores the received control information DC2 in the storage device 11. The execution of step S4 may be performed at any point after step S3 and before step S5 and is not limited to the illustrated example.

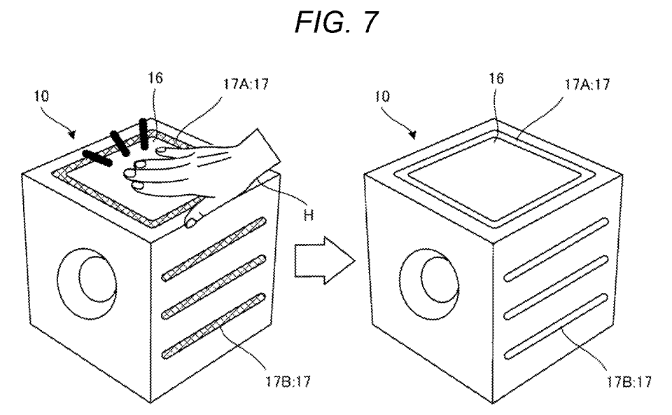

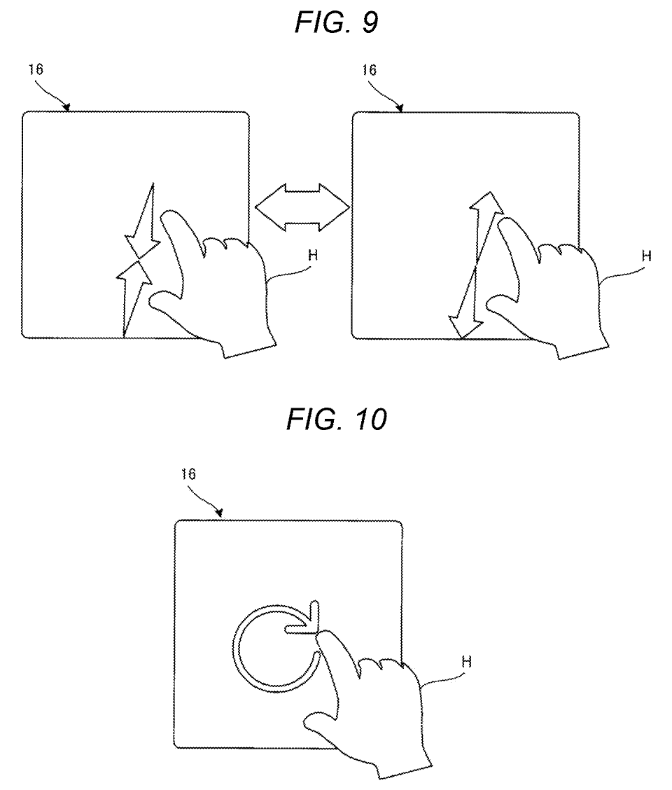

After step S4, in step S5, the processing device 12 determines whether the input device 16 accepts the first operation. More specifically, in step S5, the processing device 12 functioning as the illumination control unit 12b determines whether the first operation is performed on the input device 16. The first operation is a predetermined operation associated with the control of the overall brightness of the plurality of light sources 17a. A specific example of this operation will be described later with reference to FIGS. 7 and 9.

When the input device 16 accepts the first operation (YES in step S5), the processing device 12 controls the brightness of the plurality of light sources 17a in step S6. When executing step S6 for the first time, the processing device 12 causes the plurality of light sources 17a to emit light in a preset light emission pattern and light emission color. When executing step S6 from the second time onward, the processing device 12 causes the plurality of light sources 17a to emit light in the first mode after step S9 is executed, and causes the plurality of light sources 17a to emit light in the second mode after step S10 is executed.

Controlling the brightness of the plurality of light sources 17a in step S6 when the input device 16 accepts the first operation (YES in step S5) includes controlling the overall brightness of the plurality of light sources 17a. Thus, the brightness of the plurality of light sources 17a can be collectively controlled.

Also, controlling the brightness of the plurality of light sources 17a in step S6 when the input device 16 accepts the first operation (YES in step S5) includes turning on the plurality of light sources 17a at a first brightness when the first operation is accepted by the input device 16 for the first time, and controlling the brightness of the plurality of light sources 17a to a second brightness different from the first brightness when the first operation is accepted by the input device 16 for the second time. Thus, the brightness of the plurality of light sources 17a can be changed in multiple steps or steplessly by the first operation.

Moreover, when the input device 16 accepts the first operation (YES in step S5) during a period in which the plurality of light sources 17a emit light in the first mode based on the first combination in step S9, the first combination is maintained and the overall brightness of the plurality of light sources 17a is changed. That is, the brightness of all of the plurality of light sources 17a is changed without changing the mode from the first mode. Thus, the overall brightness of the plurality of light sources 17a can be changed while the first combination is maintained.

When the input device 16 accepts the first operation (YES in step S5) during a period in which the plurality of light sources 17a emit light in the second mode based on the second combination in step S10, the second combination is maintained and the overall brightness of the plurality of light sources 17a is changed. That is, the brightness of all of the plurality of light sources 17a is changed without changing the mode from the second mode. Thus, the overall brightness of the plurality of light sources 17a can be changed while the second combination is maintained.

After step S6 or when the input device 16 does not accept the first operation (NO in step S5), the processing device 12 in step S7 determines whether the input device 16 accepts a second operation different from the first operation. More specifically, in step S7, the processing device 12 functioning as the illumination control unit 12b determines whether the second operation is performed on the input device 16. The second operation is a predetermined operation associated with the control of the light emission mode of the plurality of light sources 17a. A specific example of this operation will be described later with reference to FIGS. 7 and 10.

When the input device 16 accepts the second operation (YES in step S7), in step S8, the processing device 12 functioning as the illumination control unit 12b determines whether the second operation on the input device 16 is performed for an even-numbered time.

When the second operation on the input device 16 is performed for an odd-numbered time (NO in step S8), in step S9, the processing device 12 functioning as the illumination control unit 12b causes the plurality of light sources 17a to emit light in the first mode based on the control information DC1. The light emission of the plurality of light sources 17a in the first mode is the light emission in the light emission pattern and the light emission color of the first combination represented by the control information DC1. Therefore, causing the plurality of light sources 17a to emit light in the first mode in step S9 includes causing the plurality of light sources 17a to emit light based on the control information DC1 in the first mode. As the control information DC1 is used in this manner, the plurality of light sources 17a can be made to emit light in the first mode without performing the first input again.

As described above, when the input device 16 accepts the second operation (YES in step S7, NO in step S8), the processing device 12 in step S9 causes the plurality of light sources 17a to emit light in the first mode based on the first combination.

Meanwhile, when the second operation on the input device 16 is performed for an even-numbered time (YES in step S8), in step S10, the processing device 12 functioning as the illumination control unit 12b causes the plurality of light sources 17a to emit light in the second mode based on the control information DC2. The light emission of the plurality of light sources 17a in the second mode is the light emission in the light emission pattern and the light emission color of the second combination represented by the control information DC2. Therefore, causing the plurality of light sources 17a to emit light in the second mode in step S10 includes causing the plurality of light sources 17a to emit light based on the control information DC2 in the second mode. As the control information DC2 is used in this manner, the plurality of light sources 17a can be made to emit light in the second mode without performing the second input again.

As described above, when the input device 16 accepts the second operation again (YES in step S7, YES in step S8), the processing device 12 in step S10 causes the plurality of light sources 17a to emit light in the second mode based on the second combination.

After step S9 or step S10, or when the input device 16 does not accept the second operation (NO in step S7), the processing device 12 in step S11 determines whether a third input is accepted. More specifically, in step S11, the processing device 12 functioning as the illumination control unit 12b receives the control information DC1 again from the terminal device 30 via the communication device 13 and thus accepts the third input representing the control information DC1 again. The third input represents a third combination that is a combination of the lighting and blinking pattern and the light emission color of the plurality of light sources 17a in the first mode and is different from the first combination.

When the input device 16 accepts the third input (YES in step S11), the processing device 12 in step S12 changes the content of the first mode, based on the new control information DC1. More specifically, in step S12, the processing device 12 functioning as the illumination control unit 12b replaces the control information DC1 stored in the storage device 11 with the new control information DC1. Thus, in the subsequent step S9, the processing device 12 functioning as the illumination control unit 12b causes the plurality of light sources 17a to emit light in the light emission pattern and the light emission color of the third combination.

As described above, after step S12, when the input device 16 accepts the second operation (YES in step S7, NO in step S8), the processing device 12 in step S9 causes the plurality of light sources 17a to emit light in the first mode based on the third combination. Thus, the combination of the lighting and blinking pattern and the light emission color of the plurality of light sources 17a in the first mode can be changed.

After step S12, or when the input device 16 does not accept the third input (NO in step S11), the processing device 12 in step S13 determines whether to end the processing. This determination is made, for example, based on an operation on the terminal device 30 or the input device 16 by the user.

When the processing is not to be ended (NO in step S13), the processing device 12 functioning as the illumination control unit 12b proceeds to the above-described step S5. Thus, of the above-described steps S5 to S12, steps corresponding to an operation on the input device 16 are repeatedly executed.

When the processing is to be ended (YES in step S13), the processing device 12 functioning as the illumination control unit 12b ends the processing.

### 1-5. First Operation and Second Operation

FIG. 7 illustrates the first operation. On the left side in FIG. 7, the illumination device 10 before the acceptance of the first operation on the input device 16 is illustrated. On the right side in FIG. 7, the illumination device 10 after the acceptance of the first operation on the input device 16 is illustrated. In FIG. 7, the illumination unit 17 in the light emitting state is shaded.

As shown in FIG. 7, when the first operation is performed on the input device 16 (YES in the above-described step S5), the brightness of the illumination unit 17 changes in the above-described step S6. In the example illustrated in FIG. 7, the first operation is a short press touch operation with a hand H, and the illumination unit 17 changes from the on state to the off state in response to the first operation. When the illumination unit 17 is in the off state in response to the first operation, the illumination unit 17 may be turned on in the first mode or the second mode by the second operation in the subsequent step S7.

The brightness of the illumination unit 17 may gradually change in stages or steplessly according to the number of times of the first operation. For example, according to the number of times of the first operation, the brightness may be periodically changed in an order of brightness 100% → brightness 80% → brightness 60% →... brightness 0% → brightness 100% → brightness 80%..., or may be periodically changed in an order of brightness 100% → brightness 80% → brightness 60% →... brightness 0% → brightness 20% → brightness 40% →... brightness 100% → brightness 80%.... The brightness of 0% indicates the off state.

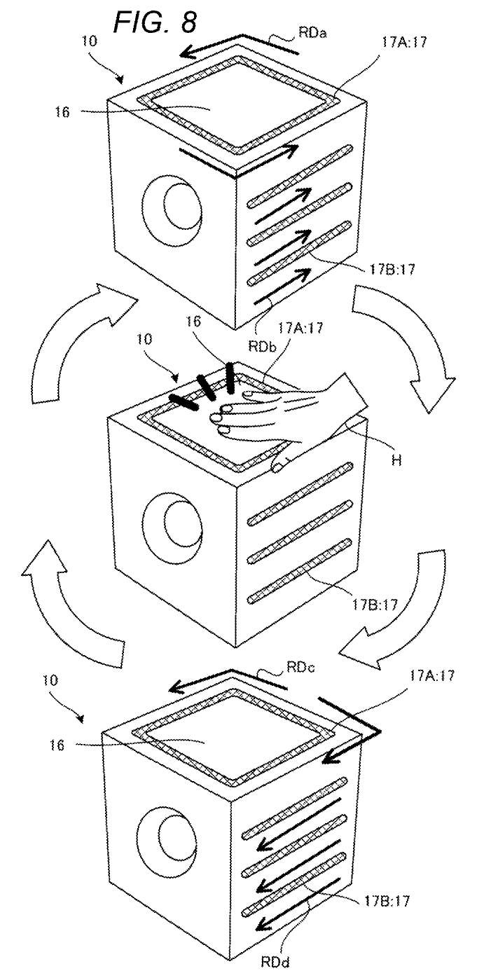

FIG. 8 illustrates the second operation. At the center in FIG. 8, the illumination device 10 before the acceptance of the second operation on the input device 16 is illustrated. At the top in FIG. 8, the illumination device 10 causing the illumination unit 17 to emit light in the first mode after the acceptance of the second operation on the input device 16 is illustrated. At the bottom in FIG. 8, the illumination device 10 causing the illumination unit 17 to emit light in the second mode after the acceptance of the second operation on the input device 16 is illustrated. In FIG. 8, the illuminating unit 17 in the light emitting state is shaded.

As shown in FIG. 8, when the second operation is performed on the input device 16 (YES in step S7), the state where the illumination unit 17 emits light in the first mode in step S9 and the state where the illumination unit 17 emits light in the second mode in step S10 are alternately switched. In the example illustrated in FIG. 8, the second operation is a long press touch operation with the hand H.

In the first mode, the brightness or the light emission color of the illumination unit 17A changes so as to move along a circumferential direction RDa of the illumination device 10, and in conjunction with this, the brightness or the light emission color of each illumination unit 17B changes so as to move along a direction RDb toward the rear of the illumination device 10. In the second mode, the brightness or the light emission color of the illumination unit 17A changes so as to move along a direction RDc toward the front of the illumination device 10, and in conjunction with this, the brightness or the light emission color of each illumination unit 17B changes so as to move along a direction RDd toward the front of the illumination device 10. However, the details of the first mode and the second mode are not limited to the illustrated example and are freely set.

FIG. 9 illustrates another example of the first operation. The first operation is not limited to the above-described short press touch operation and may be a pinch operation as shown in FIG. 9. That is, the brightness of the illumination unit 17 may be gradually decreased in stages or steplessly in response to the first operation by a pinch-in operation illustrated on the left side in FIG. 9, or the brightness of the illumination unit 17 may be gradually increased in stages or steplessly in response to the first operation by a pinch-out operation illustrated on the right side in FIG. 9.

FIG. 10 illustrates another example of the second operation. The second operation is not limited to the above-described long-press touch operation, and may be an operation of drawing a circle as illustrated in FIG. 10. That is, the first mode and the second mode of the illumination unit 17 may be switched in response to the second operation by the operation of drawing the circle illustrated in FIG. 10.

As described above, when the input device 16 is a touch sensor that detects a touch, the first operation and the second operation may be two different operations among a long press, a short press, a single tap, a double tap, a pinch operation, an operation of drawing a circle, a scroll in a first direction, and a scroll in a second direction different from the first direction, on the touch sensor. Thus, the first operation and the second operation that are easy to handle can be realized. Using the touch sensor as the input device 16 is also advantageous in that an excellent design of the housing 20 of the illumination device 10 can be easily achieved.

### 1-6. Setting and Change of Mode

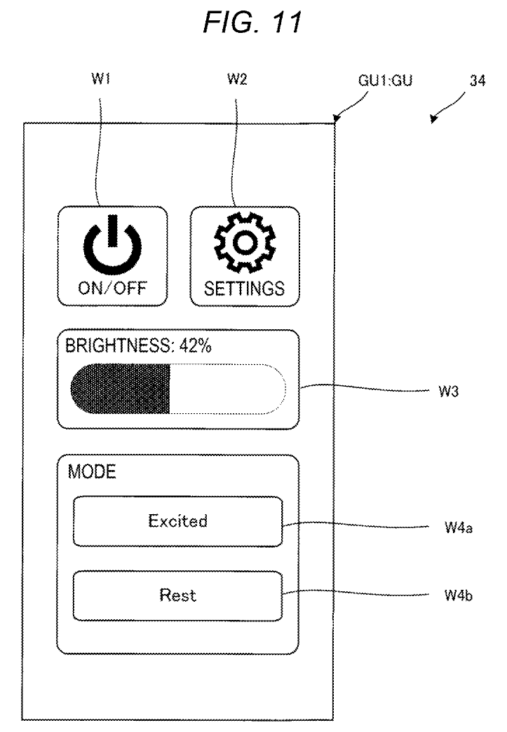

FIG. 11 illustrates an example of a display used for accepting the first input and the second input. The terminal device 30 causes the display device 34 to display an image GU1 as shown in FIG. 11. The image GU1 is an image GU that is an image for a GUI (graphical user interface) used for control and settings of the illumination unit 17. The image GU1 includes widgets W1, W2, W3, W4a, W4b. The widgets may be rephrased as UI components, components, or the like.

The widget W1 is an element for accepting an operation of switching between enabling and disabling of the illumination unit 17. The operation on the widget W1 enables the function of the illumination unit 17 and starts the above-described illumination control method. Also, the control information DC1 and control information DC2 that are already set are transmitted from the terminal device 30 to the illumination device 10 in response to the operation on the widget W1.

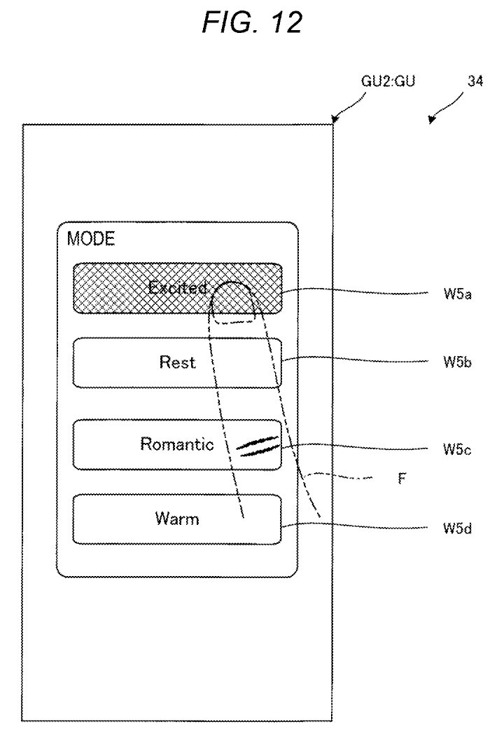

The widget W2 is an element for changing the setting contents of the illumination unit 17. In response to the operation on the widget W2, images GU2, GU3, GU4 shown in FIGS. 12-14, described later, for changing the setting contents of the illumination unit 17 are displayed on the display device 34.

The widget W3 is an element for accepting an operation of changing the brightness of the illumination unit 17. In response to the operation on the widget W3, control information for changing the brightness of the illumination unit 17 is transmitted from the terminal device 30 to the illumination device 10. Upon receiving the control information for changing the brightness of illumination unit 17, the illumination device 10 controls the brightness of illumination unit 17 to the brightness based on the control information.

The widget W4a is an element for accepting an operation of switching the light emission pattern and the light emission color of the illumination unit 17 to the first mode. In response to the operation on the widget W4a, a control signal for causing the illumination unit 17 to emit light in the first mode is transmitted from the terminal device 30 to the illumination device 10. Upon receiving the control signal, the illumination device 10 causes the illumination unit 17 to emit light in the first mode in response to the control signal.

The widget W4b is an element for accepting an operation of switching the light emission pattern and the light emission color of the illumination unit 17 to the second mode. In response to the operation on the widget W4b, a control signal for causing the illumination unit 17 to emit light in the second mode is transmitted from the terminal device 30 to the illumination device 10. Upon receiving the control signal, the illumination device 10 causes the illumination unit 17 to emit light in the second mode in response to the control signal.

FIG. 12 illustrates an example of a display used for setting the first mode and the second mode. An image GU2 as shown in FIG. 12 is displayed on the display device 34 via the operation on the widget W2. The image GU2 is an image GU that is a GUI image used for setting the combination of the light emission pattern and the light emission color of the illumination unit 17. The image GU2 includes widgets W5a, W5b, W5c, W5d. FIG. 12 illustrates a state where the widget W5a is operated by a finger F.

Each of the widgets W5a, W5b, W5c, W5d is an element for setting a mode of a light emission pattern and a light emission color as the first mode or the second mode, when selected. The widgets W5a, W5b, W5c, W5d are associated with presets of combinations of light emission patterns and light emission colors. In response to the operation on the widgets W5a, W5b, W5c, W5d, the mode of the light emission pattern and the light emission color corresponding to the selected widget is set as the first mode or the second mode. The contents of the set first mode and second mode are displayed at the above-described widgets W4a, W4b.

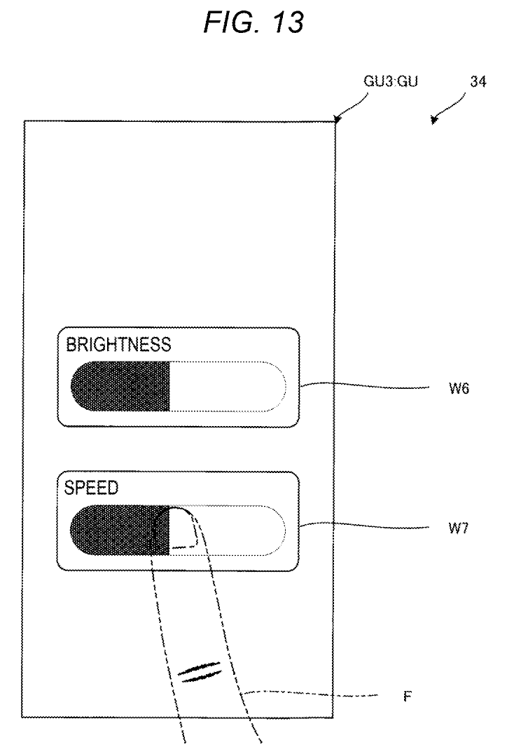

FIG. 13 illustrates an example of a display used for changing the lighting and blinking pattern of a plurality of light sources. An image GU3 as shown in FIG. 13 is displayed on the display device 34 via the operation on the widget W2. The image GU3 is an image GU that is a GUI image used for setting the brightness and the speed of change in the light emission pattern of the illumination unit 17 in the first mode and the second mode. The image GU3 includes widgets W6, W7. FIG. 13 illustrates a state where the widget W7 is operated by the finger F.

The widget W6 is an element for accepting an operation of changing the brightness in the first mode and the second mode. For example, in response to the operation on the widget W6 after selecting the mode for which the setting is to be changed, the brightness in the first mode and the second mode is changed.

The widget W7 is an element for accepting an operation of changing the speed of change in the light emission patterns in the first mode and the second mode. For example, in response to the operation on the widget W7 after selecting the mode for which the setting is to be changed, the speed of change in the light emission patterns of the first mode and the second mode is changed.

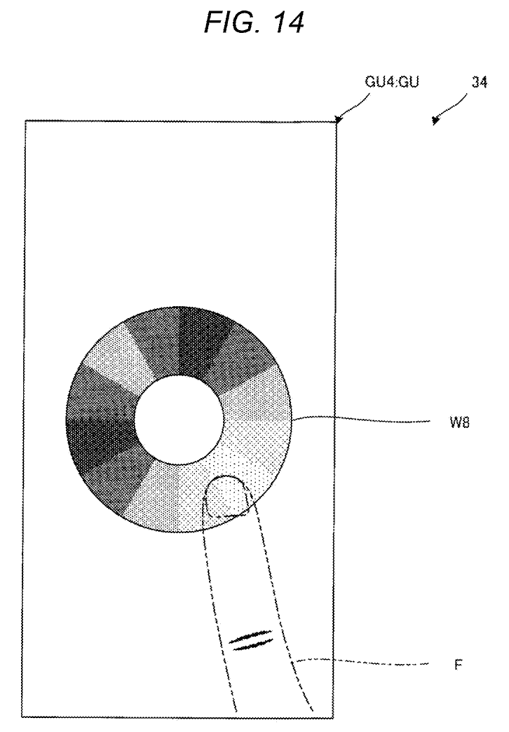

FIG. 14 illustrates an example of a display used for changing the light emission colors of the plurality of light sources 17a. An image GU4 as shown in FIG. 14 is displayed on the display device 34 via the operation on the widget W2. The image GU4 is an image GU that is a GUI image used for setting the light emission colors in the first mode and the second mode of the illumination unit 17. The image GU4 includes a widget W8. FIG. 14 illustrates a state where the widget W8 is operated by the finger F.

The widget W8 is an element for accepting an operation of changing the light emission colors in the first mode and the second mode. For example, in response to the widget W8 after selecting the mode for which the setting is to be changed, the light emission colors in the first mode and the second mode are changed. In the example illustrated in FIG. 14, the widget W8 has a form like a color chart. The form of the widget W8 is not limited to the illustrated example as long as the widget W8 can accept the operation of changing the light emission colors in the first mode and the second mode.

In the above-described illumination control method, the combination of the lighting and blinking pattern and the light emission color of the plurality of light sources 17a can be switched between the first combination and the second combination, and the brightness of the plurality of light sources 17a can be controlled by the first operation. Therefore, a variety of light emission of the plurality of light sources 17a can be realized. Moreover, switching between the first mode and the second mode can be performed by repeating the second operation. Therefore, even when the plurality of light sources 17a emit light in various ways, the operation of switching between these modes is easy. Also, since the second operation is an operation different from the first operation, the operation of switching between these modes is easy for the user to understand. From the above, more varied expressions can be easily created by illumination.

### 2. Modification Examples

The embodiment exemplified above can variously be modified. Specific aspects of modifications applicable to the above embodiment will be described below. Two or more aspects freely selected from the following examples can be combined together as appropriate to the extent that no contradiction occurs.

### 2-1. Modification Example 1

In the above-described embodiment, the light emission of the illumination unit 17 in response to the first operation and the second operation is described, but the illumination unit 17 may emit light in response to another operation than the first operation and the second operation, in addition to the light emission in response to the first operation and the second operation, or may emit light in a light emission pattern and a light emission color assigned in advance according to a state such as the activation of the illumination device 10 or the display of a setting screen.

### 2-2. Modification Example 2

In the above-described embodiment, an aspect is described in which the plurality of light sources 17a are made to emit light in the first mode when the second operation is performed for an odd-numbered time (NO in step S8) and in which the plurality of light sources 17a are made to emit light in the second mode when the second operation is performed for an even-numbered time (YES in step S8), but the present disclosure is not limited to this aspect and the processing device 12 may cause the plurality of light sources 17a to emit light in the second mode when the second operation is performed for an odd-numbered time (NO in step S8) and may cause the plurality of light sources 17a to emit light in the first mode when the second operation is performed for an even-numbered time (YES in step S8). In this way, the plurality of modes of the plurality of light sources 17a may be sequentially switched every time the second operation is performed.

### 2-3. Modification Example 3

In the above-described embodiment, an aspect in which the two modes of the first mode and the second mode are switched is described, but the present disclosure is not limited to this aspect and three or more modes may be switched.

### 2-4. Modification Example 4

In the above-described embodiment, an aspect in which the terminal device 30 configures settings for and performs control of one illumination device 10 is described, but the present disclosure is not limited to this aspect and the terminal device 30 may configure settings for and perform control of a plurality of illumination devices 10.

### 2-5. Modification Example 5

The programs PR1, PR2 in the above-described embodiment may be provided in a state of being recorded on a computer-readable and non-transitory recording medium. The programs PR1, PR2 in the above-described embodiment may be provided in a form of being downloaded from a server to a computer through a network.

### 3. Appendices

The present disclosure will be summarized below as appendices.

(Appendix 1) According to Appendix 1, a preferred example of the illumination control method according to the present disclosure includes: accepting a first input representing a first combination that is a combination of a lighting and blinking pattern and a light emission color of a plurality of light sources in a first mode; accepting a second input representing a second combination that is a combination of a lighting and blinking pattern and a light emission color of the plurality of light sources in a second mode and is different from the first combination; controlling a brightness of the plurality of light sources when an input device disposed in a housing of an illumination device including the plurality of light sources accepts a first operation; causing the plurality of light sources to emit light in the first mode, based on the first combination, when the input device accepts a second operation different from the first operation; and causing the plurality of light sources to emit light in the second mode, based on the second combination, when the input device accepts the second operation again.

According to the above aspect of Appendix 1, the combination of the lighting and blinking pattern and the light emission color of the plurality of light sources can be switched between the first combination and the second combination, or the brightness of the plurality of light sources can be controlled by the first operation. Therefore, a variety of light emission of the plurality of light sources can be realized. Moreover, switching between the first mode and the second mode can be performed by repeating the second operation. Therefore, even when the plurality of light sources emit light in various ways, the operation of switching between these modes is easy. Also, since the second operation is an operation different from the first operation, the operation of switching between these modes is easy for the user to understand. From the above, more varied expressions can be easily created by illumination.

(Appendix 2) According to Appendix 2 which is a preferred example of Appendix 1, the method further includes: storing control information of the first mode based on the first input; and storing control information of the second mode based on the second input, and causing the plurality of light sources to emit light in the first mode includes causing the plurality of light sources to emit light, based on the control information of the first mode, and causing the plurality of light sources to emit light in the second mode includes causing the plurality of light sources to emit light, based on the control information of the second mode. According to the above aspect of Appendix 2, the plurality of light sources can be made to emit light in the first mode or the plurality of light sources can be made to emit light in the second mode without performing the first input and the second input again each time the mode is switched.

(Appendix 3) According to Appendix 3, which is a preferred example of Appendix 1 or 2, the method further includes: accepting a third input representing a third combination that is a combination of a lighting and blinking pattern and a light emission color of the plurality of light sources in the first mode and is different from the first combination; and causing the plurality of light sources to emit light in the first mode, based on the third combination, when the input device accepts the second operation. According to the above aspect of Appendix 3, the combination of the lighting and blinking pattern and the light emission color of the plurality of light sources in the first mode can be changed.

(Appendix 4) According to Appendix 4, which is a preferred example of any one of Appendices 1 to 3, controlling the brightness of the plurality of light sources when the input device accepts the first operation is controlling an overall brightness of the plurality of light sources. According to the above aspect of Appendix 4, the brightness of the plurality of light sources can be collectively controlled.

(Appendix 5) According to Appendix 5, which is a preferred example of Appendix 4, controlling of the brightness of the plurality of light sources when the input device accepts the first operation includes: turning on the plurality of light sources at a first brightness when the first operation is accepted by the input device for a first time; and controlling the brightness of the plurality of light sources to a second brightness different from the first brightness when the first operation is accepted by the input device for a second time. According to the above aspect of Appendix 5, the brightness of the plurality of light sources can be easily controlled to at least the first brightness or the second brightness by repeating the first operation.

(Appendix 6) According to Appendix 6, which is a preferred example of any one of Appendices 1 to 5, the method further includes maintaining the first combination and changing an overall brightness of the plurality of light sources when the input device accepts the first operation during a period in which the plurality of light sources are made to emit light in the first mode, based on the first combination. According to the above aspect of Appendix 6, the overall brightness of the plurality of light sources can be changed while the first combination is maintained.

(Appendix 7) According to Appendix 7, which is a preferred example of any one of Appendices 1 to 6, the input device is a touch sensor that detects a touch, and the first operation and the second operation are two different operations among a long press, a short press, a single tap, a double tap, a pinch operation, an operation of drawing a circle, a scroll in a first direction, and a scroll in a second direction different from the first direction, on the touch sensor. According to the above aspect of Appendix 7, the first operation and the second operation that are easy to handle can be realized. Using the touch sensor is also advantageous in that an excellent design of the housing of the illumination device can be easily achieved.

(Appendix 8) According to Appendix 8, a preferred example of the illumination device according to the present disclosure includes: a plurality of light sources; a housing in which the plurality of light sources are disposed; an input device that is disposed in the housing and accepts a first operation and a second operation different from the first operation; and a control device that executes accepting a first input representing a first combination that is a combination of a lighting and blinking pattern and a light emission color of the plurality of light sources in a first mode, accepting a second input representing a second combination that is a combination of a lighting and blinking pattern and a light emission color of the plurality of light sources in a second mode and is different from the first combination, controlling a brightness of the plurality of light sources when the input device accepts the first operation, causing the plurality of light sources to emit light in the first mode, based on the first combination, when the input device accepts the second operation, and causing the plurality of light sources to emit light in the second mode, based on the second combination, when the input device accepts the second operation again.

According to the above aspect of Appendix 8, the combination of the lighting and blinking pattern and the light emission color of the plurality of light sources can be appropriately set in each of the first combination and the second combination, or the brightness of the plurality of light sources can be controlled by the first operation. Therefore, a variety of light emission of the plurality of light sources can be realized. Moreover, switching between the first mode and the second mode can be performed by repeating the second operation. Therefore, even when the plurality of light sources emit light in various ways, the operation of switching between these modes is easy. Also, since the second operation is an operation different from the first operation, the operation of switching between these modes is easy for the user to understand. From the above, more varied expressions can be easily created by illumination.

What is claimed is:

1. An illumination control method comprising:
accepting a first input representing a first combination that is a combination of a lighting and blinking pattern and a light emission color of a plurality of light sources in a first mode;
accepting a second input representing a second combination that is a combination of a lighting and blinking pattern and a light emission color of the plurality of light sources in a second mode and is different from the first combination;
controlling a brightness of the plurality of light sources when an input device disposed in a housing of an illumination device including the plurality of light sources accepts a first operation;
causing the plurality of light sources to emit light in the first mode, based on the first combination, when the input device accepts a second operation different from the first operation; and
causing the plurality of light sources to emit light in the second mode, based on the second combination, when the input device accepts the second operation again.

2. The illumination control method according to claim 1, further comprising:
storing control information of the first mode based on the first input; and
storing control information of the second mode based on the second input, wherein
the causing the plurality of light sources to emit light in the first mode includes causing the plurality of light sources to emit light, based on the control information of the first mode, and
the causing the plurality of light sources to emit light in the second mode includes causing the plurality of light sources to emit light, based on the control information of the second mode.

3. The illumination control method according to claim 1, further comprising:
accepting a third input representing a third combination that is a combination of a lighting and blinking pattern and a light emission color of the plurality of light sources in the first mode and is different from the first combination; and
causing the plurality of light sources to emit light in the first mode, based on the third combination, when the input device accepts the second operation.

4. The illumination control method according to claim 1, wherein
the controlling the brightness of the plurality of light sources when the input device accepts the first operation is controlling an overall brightness of the plurality of light sources.

5. The illumination control method according to claim 4, wherein
the controlling of the brightness of the plurality of light sources when the input device accepts the first operation includes:
turning on the plurality of light sources at a first brightness when the first operation is accepted by the input device for a first time; and
controlling the brightness of the plurality of light sources to a second brightness different from the first brightness when the first operation is accepted by the input device for a second time.

6. The illumination control method according to claim 1, further comprising:
maintaining the first combination and changing an overall brightness of the plurality of light sources when the input device accepts the first operation during a period in which the plurality of light sources are made to emit light in the first mode, based on the first combination.

7. The illumination control method according to claim 1, wherein
the input device is a touch sensor that detects a touch, and
the first operation and the second operation are two different operations among a long press, a short press, a single tap, a double tap, a pinch operation, an operation of drawing a circle, a scroll in a first direction, and a scroll in a second direction different from the first direction, on the touch sensor.

8. An illumination device comprising:
a plurality of light sources;
a housing in which the plurality of light sources are disposed;
an input device disposed in the housing and configured to accept a first operation and a second operation different from the first operation; and
a control device configured to execute
accepting a first input representing a first combination that is a combination of a lighting and blinking pattern and a light emission color of the plurality of light sources in a first mode,
accepting a second input representing a second combination that is a combination of a lighting and blinking pattern and a light emission color of the plurality of light sources in a second mode and is different from the first combination,
controlling a brightness of the plurality of light sources when the input device accepts the first operation,
causing the plurality of light sources to emit light in the first mode, based on the first combination, when the input device accepts the second operation, and
causing the plurality of light sources to emit light in the second mode, based on the second combination, when the input device accepts the second operation again.
